(19) United States
(12) Patent Application Publication
(10) Pub. No.: US 2025/0138898 A1
(43) Pub. Date: May 1, 2025

(54) DYNAMIC CUSTOMIZABLE TUNING TO IMPROVE CUSTOMER EXPERIENCE

(71) Applicant: DELL PRODUCTS L.P., Round Rock, TX (US)

(72) Inventors: Farzad Khosrowpour, Pflugerville, TX (US); Suraj Varma, Portland, OR (US)

(21) Appl. No.: 18/499,420

(22) Filed: Nov. 1, 2023

(51) Int. Cl. G06F 9/50

(52) U.S. Cl. CPC G06F 9/5038; G06F 9/5094

(57) ABSTRACT

An information handling system determines a workload class currently running in the foreground, and determines a selected optimization priority. The system determines a configuration setting based on the workload class currently running in the foreground and the selected optimization priority, and applies the configuration setting.

### FIELD OF THE DISCLOSURE

The present disclosure generally relates to information handling systems, and more particularly relates to dynamic customizable tuning to improve customer experience.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system determines a workload class currently running in the foreground, and determines a selected optimization priority. The system determines a configuration setting based on the workload class currently running in the foreground and the selected optimization priority, and applies the configuration setting.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of an environment for dynamic customizable tuning, according to an embodiment of the present disclosure;

FIG. 3 is a block diagram of a user interface that allows the user to select an optimization preference for dynamic customizable tuning, according to an embodiment of the present disclosure;

FIG. 4 is a block diagram of relationships between operating system power modes and user-selectable thermal table modes, according to an embodiment of the present disclosure;

FIG. 5 shows a flowchart of a method for building a software library of optimal configuration settings during platform development, according to an embodiment of the present disclosure;

FIG. 6 shows a flowchart of a method for determining an optimal configuration setting to apply during runtime, according to an embodiment of the present disclosure;

FIG. 7 shows a table of optimal configuration settings for each workload class and priority based on a user's preference, according to an embodiment of the present disclosure; and

FIG. 8 shows a table of control settings based on a user's preference, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

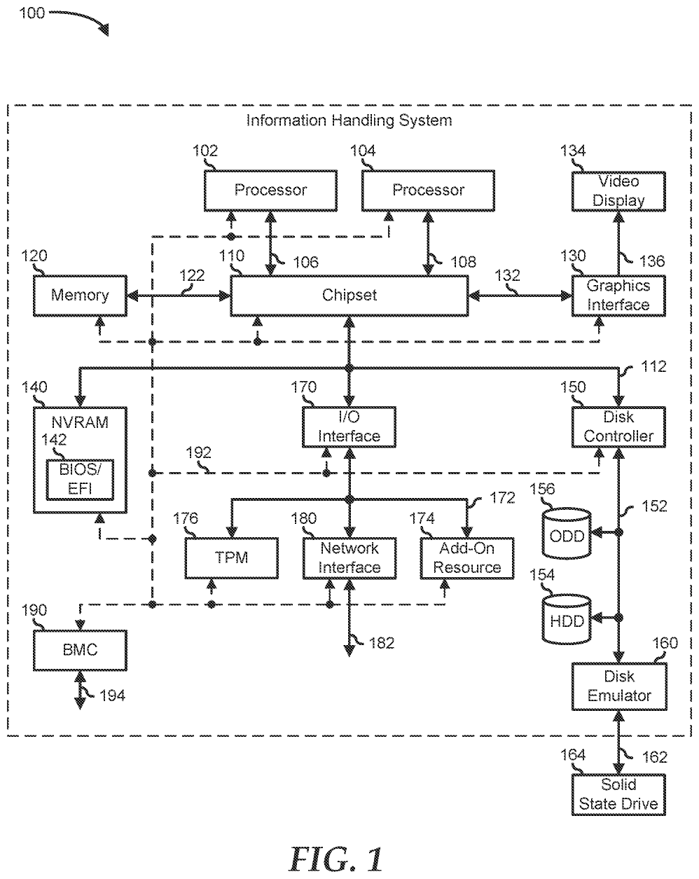

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC)® channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include a I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Managing thermal, power, performance, and acoustic characteristics of an information handling system optimizes a user's experience and productivity. In addition to controls associated with the management of thermal, power, performance, and acoustic characteristics, some information handling systems may include controls related to application selection and optimization, independent audio controls, and the ability to launch applications, among others. These controls typically have an association with application features. However, some application features do not have a one to one relationship with these system management controls. Exposing all the management controls with the application features may cause confusion about the myriad and/or sometimes conflicting options. Accordingly, the present disclosure provides a simplified and dynamic system of resource management. The user simply provides his or her preference and the system and method adapt to changing requirements of the information handling system, optimizing the configuration settings to provide a positive impact on a user's experience.

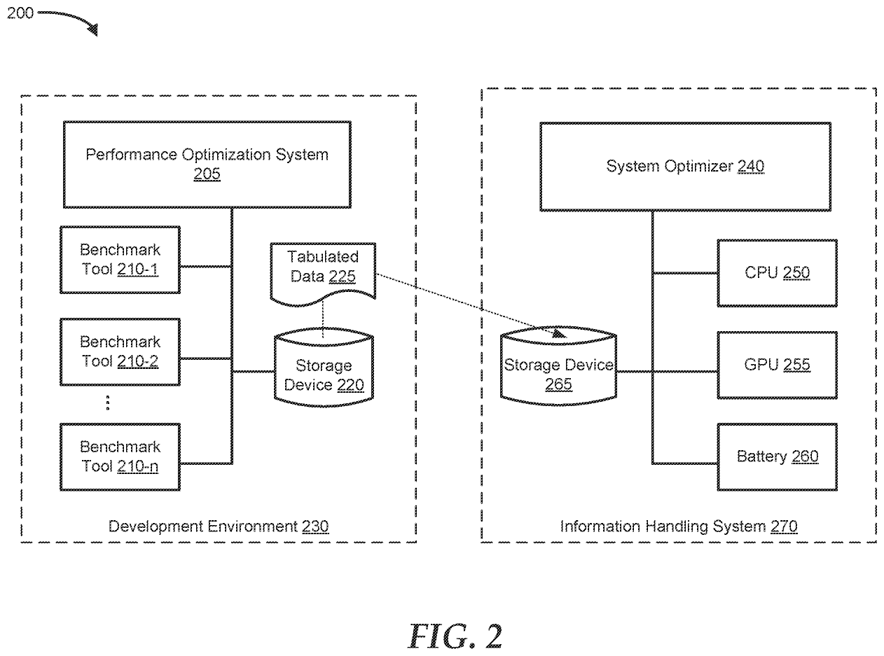

FIG. 2 shows an environment 200 for dynamic customizable tuning to improve user experience. Environment 200 includes a development environment 230 and an information handling system 270. Development environment 230 includes a performance optimization system 205, benchmark tools 210-1 through 210-n, and a storage device 220. Storage device 220 may store tabulated data 225. Information handling system 270 includes a system optimizer 240, a CPU 250, a GPU 255, a battery 260, and a storage device 265. Development environment 230 may be included in an information handling system similar to information handling system 100 of FIG. 1. Similarly, information handling system 270 may also be similar to information handling system 100 of FIG. 1. The components of environment 200 may be implemented in hardware, software, firmware, or any combination thereof.

Manual steps are typically used to find an optimal operating setting of a platform. For example, platforms such as workstations or gaming systems are typically tuned for performance, whereas platforms, such as business or home user systems are typically tuned for optimal battery runtime. The tradeoffs between the platforms are usually decided at design time. However, there is no dynamic mechanism to adjust the platforms in response to changes in customer intent and needs. Environment 200 includes a system and method to address this gap among other issues, such as to allow automatic tuning at runtime to take advantage of possible improvements in performance, power, and acoustics as needed.

Performance optimization system 205 may be configured to build libraries to be used by system optimizer 240 to analyze and tune system conditions to improve user experience. Performance optimization system 205 may use benchmark tools 210-1 through 210-n to generate benchmarks that can be used in determining optimal configuration settings for each platform, system power mode, and workload class. Benchmark tools 210 include applications and/or test suite developed in-house and/or commercially available. The applications and/or test suites may be developed to leverage simulated workloads that map to workload in actual user environments. Examples of commercially available applications and test suites include a CINEBENCH test suite, Futuremark 3DMark®, Futuremark PCMark®, etc. In particular, benchmark tools 210 include one or more automation tools to provide various metrics, such as performance metrics, battery usage, benchmark scores, among others.

Accordingly, performance optimization system 205 may perform a workload classification operation and collect data to enable the sorting of configuration settings based on one or more parameters, such as performance, battery runtime, and acoustics level. In this example, the configuration settings with parameters associated with decreased performance, decreased battery runtime, and increased acoustics may be discarded. Once the information is sorted, performance optimization system 205 may tabulate the controls for the platform in each workload class according to system power sources, such as for AC and direct current (DC). The tabulated information can now be used in the field based on the user's intent.

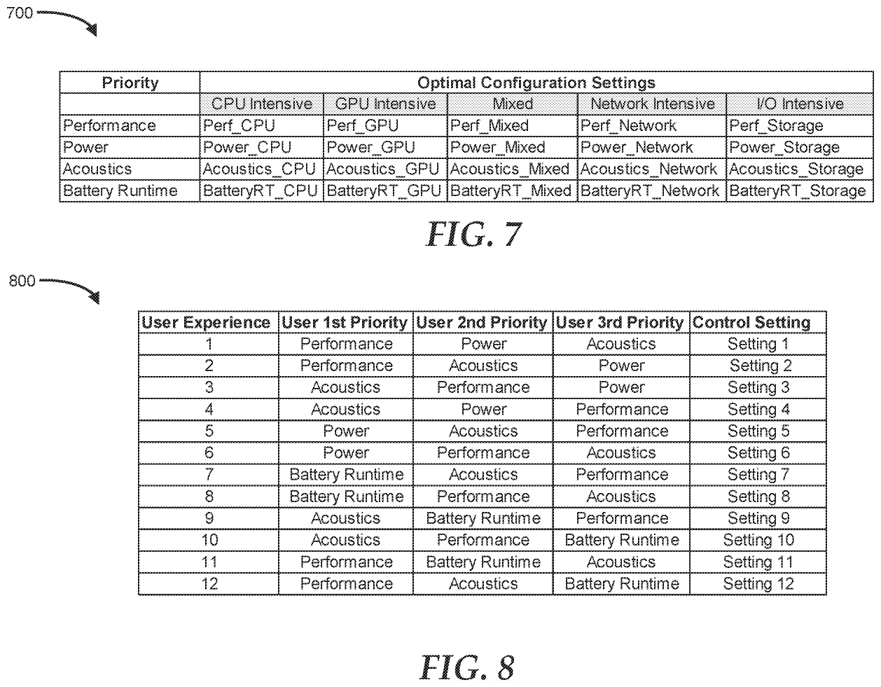

Performance and/or optimization data used in generating the benchmarks may be stored in storage device 220. The derived optimal configuration settings may be tabulated in tabulated data 225, which is similar to a table 700 of FIG. 7 and a table 800 of FIG. 8. The optimal configuration settings may then be packaged and included during the deployment of system optimizer 240 to information handling system 270. The configuration settings may include settings associated with CPU 250, GPU 255, battery 260, and storage device 265. The configuration settings may also include settings associated with other resources, such as power system, network, and cooling system resources. For example, a configuration setting associated with a performance mode may include a certain power level setting for CPU 250, a clock rate and frame per second rate for CPU 250, a read/write ratio setting for storage device 265, and a certain buffer size for the network resource. The configuration settings may also include certain settings associated with certain application features.

System optimizer 240 may be configured to run in the background and perform automated performance tuning and utilization monitoring through usage analysis and learning. For example, system optimizer 240 may be configured to analyze current system workload through resource utilization of various components, such as CPU 250, GPU 255, and storage devices 265. System optimizer 240 may also be configured to analyze other data associated with CPU 250, GPU 255, battery 260, storage device 265, and network resources of information handling system 270 among others to determine an optimal configuration setting. In one embodiment, the optimal configuration setting may be based on metrics associated with one or more simulated workload classes. For example, system optimizer 240 may analyze battery usage, performance, network, and I/O data, among others.

System optimizer 240 may use a control setting based on the user-selected options and preferences, which enables application, hardware, power, cooling, acoustic features, etc. Because a user can choose a preference from a hierarchy of priorities, system optimizer 240 may prioritize the user's preference over other concerns. For example, system optimizer 240 may prioritize acoustics over performance and power management. Accordingly, system optimizer 240 may select the control setting to support the user's priorities. The control setting may utilize the optimal configuration setting to tune specific features to support the user's selection. For example, system optimizer 240 may select control settings 9 or 10, as shown in table 800 of FIG. 8, based on the user's priorities. System optimizer 240 may then choose one of the optimal configuration settings based on the user's priority and the current workload.

However, some of the features may have conflicts with other features. For example, increasing the performance may also increase the heat and/or the battery power consumption. Accordingly, system optimizer 240 may also manage one or more conflicts and perform arbitrations as needed. For example, system optimizer 240 may adjust the configuration settings utilized in tuning the system, such as increasing or decreasing the performance settings based on whether the system is plugged into an alternating current (AC) power source or using a battery. In addition, other features that are not relevant to the user's selections may be disabled.

CPU 250 may be similar to processors 102 and 104 of FIG. 1. GPU 255 may be similar to graphics interface 130 of FIG. 1. Battery 260 may be used to provide power to information handling system 270 when it is not plugged into an AC power source. Storage devices 220 and 265 may be persistent data storage devices and can include solid-state disks, hard disk drives, magnetic tape libraries, optical disk drives, magneto-optical disk drives, compact disk drives, compact disk arrays, disk array controllers, and/or any computer-readable medium operable to store data.

Those of ordinary skill in the art will appreciate that the configuration, hardware, and/or software components of environment 200 depicted in FIG. 2 may vary. For example, the illustrative components within environment 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

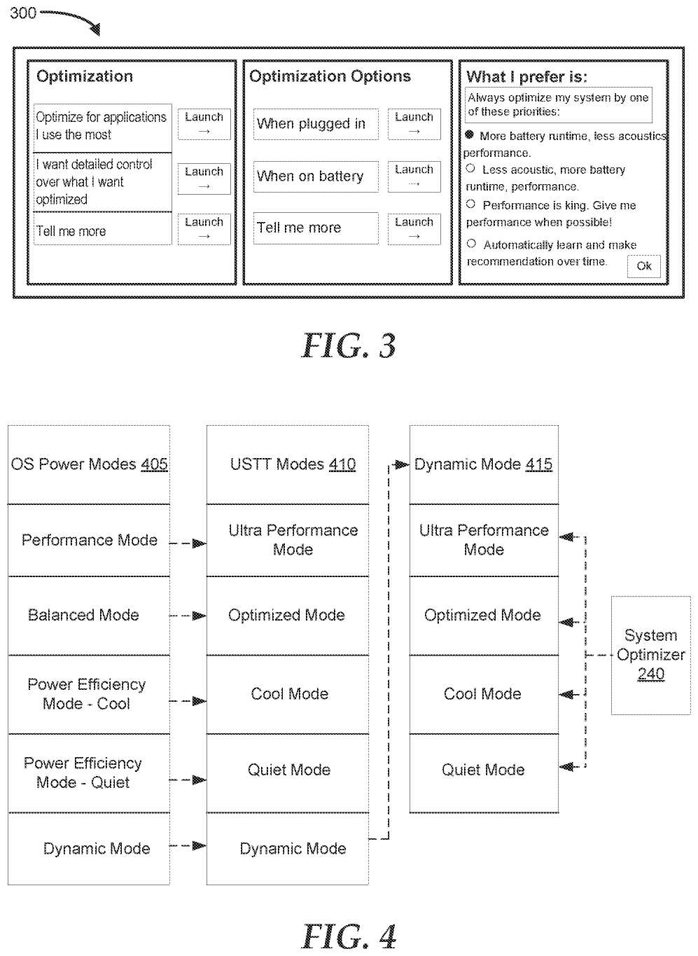

FIG. 3 shows a user interface 300 which allows the user to select an optimization preference for dynamic customizable tuning. User interface 300 may be displayed when system optimizer 240 is installed. User interface 300 can also be launched by a user. User interface 300 may display an experience-based view of choices for optimization, optimization options, and user preference. The optimization section displays choices to allow for automatic optimization for frequently used applications versus more control over selected applications. The optimization options section displays choices for optimization based on the power source of the information handling system. The user preference section displays choices for system optimization based on an ordered list of priorities, such as preference for battery runtime versus acoustics and performance, among others. User interface 300 may include user-manipulable graphical elements of an intuitive graphical user interface to allow the user to input his or her choices.

FIG. 4 shows relationships between operating system power modes 405 and a user selectable thermal table (USTT) modes 410. Operating system power modes 405 include a performance mode, a balanced mode, a power efficiency (cool) mode, a power efficiency (quiet) mode, and a dynamic mode. BIOS-based USTT modes 410 include an ultra-performance mode, an optimized mode, a cool mode, a quiet mode, and a dynamic mode. Each one of operating system power modes 405 may be associated with one of USTT modes 410. For example, the best performance mode may correspond with the ultra-performance mode. The balanced mode may correspond with the optimized mode. The best power efficiency (cool) mode may be associated with the cool mode. The best power efficiency (quiet) mode may be associated with the quiet mode. The dynamic mode of operating system power modes 405 may be associated with the dynamic mode of USTT modes 410.

The performance mode favors performance over energy consumption. The balanced mode balances performance with energy consumption. The power efficiency (cool) mode may reduce power consumption and extend battery life by reducing performance but favoring thermals when possible. The power efficiency (acoustics) mode may reduce power consumption and extend battery life by reducing performance but favoring the reduction of acoustics when possible.

A built-in logic allows system optimizer 240 to dynamically switch between various modes of USTT modes 410 by leveraging a dynamic mode 415. For example, system optimizer 240 may automatically switch from the ultra-performance mode to the optimized mode when it detects that the system transitioned from AC to DC power, also referred to as battery power. Accordingly, system optimizer 240 may automatically switch back to the ultra-performance mode from the optimized when it detects that the system transitioned back to the AC power. However, because of USTT modes 410 mapping with operating system power modes 405, the user may not see the operating system power modes changing dynamically.

System optimizer 240 can dynamically switch between the various modes by anticipating performance needs, thermal impacts, acoustic, and other concerns of the user. The adjustment may be based on factors like the workload class, system power mode, and user preference, among others. Thus, instead of the user choosing between operating system power modes 405, USTT modes 410, and other features, such as application and system applet features, system optimizer 240 may simplify the choices for the user via user interface 300 of FIG. 3.

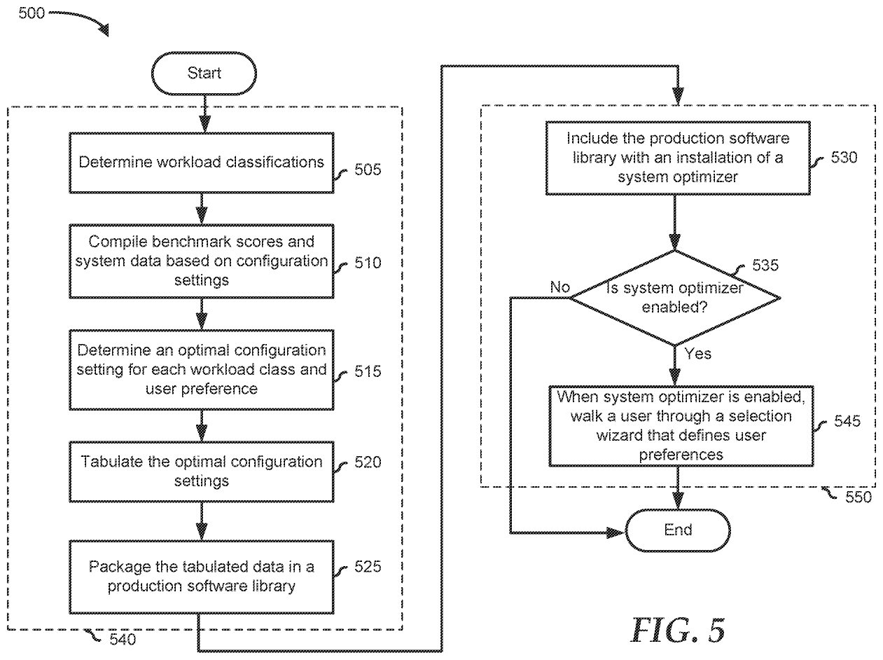

FIG. 5 shows a flowchart of a method 500 for building a software library of optimal configuration settings during platform development. Method 500 may be performed in a development environment and a user environment. In particular, development phase 540 may be performed at a development environment 230, and runtime phase 550 may be at information handling system 270. As such, method 500 may be performed by one or more components of environment 200 of FIG. 2. However, while embodiments of the present disclosure are described in terms of environment 200 of FIG. 2, it should be recognized that other systems may be utilized to perform the described method. One of skill in the art will appreciate that this flowchart explains a typical example, which can be extended to advanced applications or services in practice.

The development phase 540 of method 500 typically starts at block 505 where a workload classification may be performed in a development setting. By executing development phase 540 in the development setting, some or all of the factors and parameters associated with configuration settings can be controlled. The workload can be measured and characterized using instrumentation data on how the workload exercises the CPU, GPU, memory, storage, and other resources of the information handling system. However, because a workload can be a combination of single or multiple applications that are executed in an information handling system, different workloads can leverage system resources, such as software and/or hardware resources differently. For example, some applications may be multi-threaded, and some applications may be single-threaded. Accordingly, some applications can benefit from a faster CPU speed, and other applications from faster I/O performance. There may also be a mixed workload that includes a plurality of currently executing applications, wherein each application may leverage the hardware resources differently. Accordingly, the critical workload class may include CPU-intensive workload, GPU-intensive workload, I/O intensive workload, and network-intensive workload, among others. After classifying the workloads, the method may proceed to block 510.

At block 510, the method may execute automated benchmark tools to gather benchmark scoring and system data. In one embodiment, benchmarks for different configuration settings, and workload classes for each platform may be run. In addition, the benchmarks may also be run for each system power source mode, such as AC and DC. Results, such as benchmark metrics, component usage data, and system conditions, may be recorded for analysis. For example, the system data associated when a workload is measured and characterized by how the workload exercises the CPU, memory, storage, GPU, and network subsystems in the information handling system may be recorded. The instrumentation data on each subsystem can include hundreds of parameters. For example, for the measurement of a processor, the benchmarking tool may measure utilization, activity by core, processor queue length, turbo frequency, C-state residency, etc.

A different benchmark automation tool may be used for each workload class and/or optimization priority. For example, the CINEBENCH test suite may be used to evaluate the workload relative to the capabilities of the CPU and the GPU, generating a CINEBENCH benchmark score. Another benchmarking tool, such as Futuremark 3DMark″ may be used to evaluate the workload relative to the GPU, generating a Futuremark 3DMark® score. Futuremark PCMark on the other hand may be used to evaluate the capabilities of the information handling system when executing a mixed workload, generating a Futuremark PCMark score. To benchmark the I/O intensive workload, a Flexible I/O tester (FIO) may be used, generating a FIO score. Benchmarking tools other than the examples identified may be used. The method may proceed to block 515.

At block 515, the method may identify an optimal configuration setting based on a user's preference for optimization priorities and workload class. The method may be used to analyze the benchmark metrics, component usage, system condition, and/or other data for each configuration setting used. For example, the performance metrics of the platform associated with each configuration setting may be analyzed along with the benchmark scores. Typically, the higher the benchmark score, the higher the performance. However, each configuration setting may have an impact on benchmark scores, performance metrics, I/O, battery runtime, etc. Accordingly, the benchmark scores may be compared relative to the associated increase or decrease in the performance or other metrics with each configuration setting.

In one example, a configuration setting may be considered as an optimal configuration setting if applying the configuration setting resulted in the most power usage reduction with a minimum loss in performance, improving battery runtime. The configuration setting may also be considered as an optimal configuration setting if applying the configuration setting resulted in a moderate increase in performance but a minimum increase in noise levels and minimum power reduction also improving battery runtime. A set of rules may be used to identify thresholds in determining associated values for significant, moderate, minimum results, or the like. The configuration setting with the favorable overall impact for each workload class according to the user preference may be selected as the optimal configuration setting. The method may proceed to block 520.

At block 520, the method may tabulate the selected optimal configuration settings determined in block 515. The tabulated data may be similar to table 700 at FIG. 7 and table 800 at FIG. 8. The method may proceed to block 525. At block 525, the system optimizer may package the tabulated data associated with the identified knobs into a production software library. The method may proceed to block 530 where the production software library may be included as part of the installation of a system optimizer. The method may proceed to decision block 535. At decision block 535, the method may determine if the system optimizer is enabled. If the system optimizer is enabled, then the “YES” branch is taken, and the method proceeds to block 545. If the system optimizer is not enabled, then the “NO” branch is taken and the default operating system power modes and/or the BIOS-based USTT modes may be used. Afterwards, the method ends. At block 545, the system optimizer may walk a user through a selection wizard which defines a user intent across alternating current/direct current modes. For example, the selection wizard may include user interface 300 of FIG. 3.

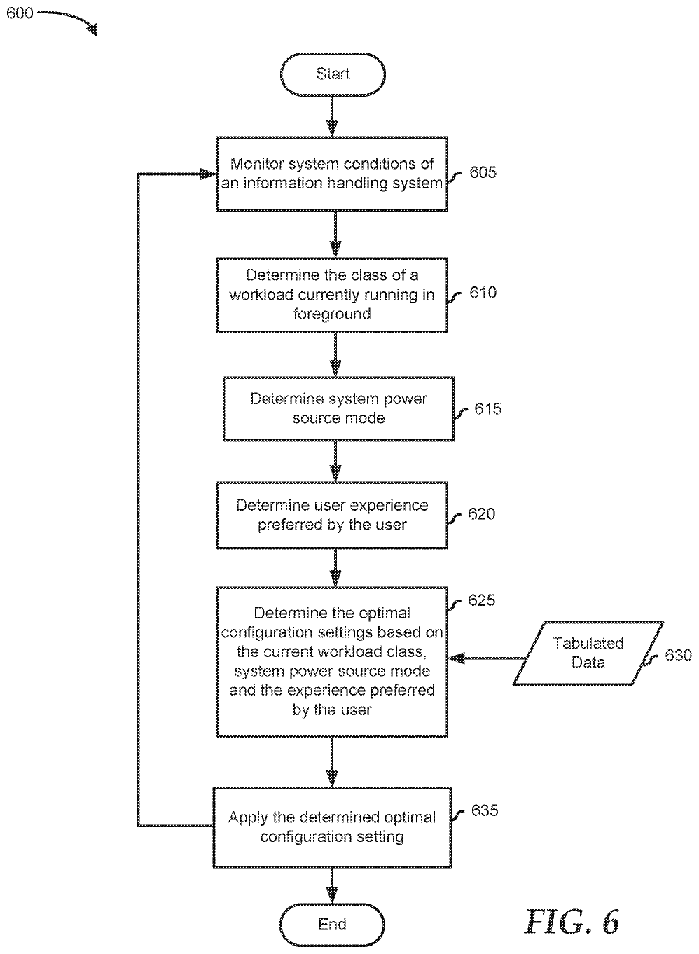

FIG. 6 shows a flowchart of a method 600 for determining an optimal configuration setting to apply during runtime. Method 600 may be performed after the user has provided his or her preferences. Method 600 may be performed as a background activity that automatically responds to the user-selected options and/or preferences. Method 600 may be performed by a system optimizer that is similar to system optimizer 240 of FIG. 2. However, while embodiments of the present disclosure are described in terms of environment 200 of FIG. 2, it should be recognized that other systems may be utilized to perform the described method. One of skill in the art will appreciate that this flowchart explains a typical example, which can be extended to advanced applications or services in practice.

Method 600 typically starts at block 605, where the system optimizer may monitor the system conditions of an information handling system. For example, the system optimizer may monitor CPU usage, battery usage, network throughput, I/O data, etc. The system optimizer may also determine if there is a change in the system conditions. The method may proceed to block 610, where the system optimizer may determine the class of the workload currently running in the foreground. For example, the method may determine whether the workload is CPU intensive, GPU intensive, mixed class, network intensive, I/O intensive, etc. The method may proceed to block 615 where the system optimizer may determine the current system power source mode. For example, the system optimizer may determine whether the information handling system is plugged into an AC power source or using its battery. The method may proceed to block 620 where the method may determine the user experience preferred by the user, which includes user optimization options and/or optimization priorities selected by the user. The user may have selected a user experience via a user interface similar to a user interface 300 of FIG. 3. For example, the user preference may be for more battery runtime, less acoustics, and performance. The method may proceed to block 625.

At block 625, the system optimizer may determine a control setting based on the workload class, system mode, and user-preferred experience based on a tabulated data 630, which is similar to table 800 of FIG. 8. For example, if the user preference is more battery runtime, less acoustics, and better performance, then the control setting to be used can be “control setting 7” based on table 800 of FIG. 8. Based on the control setting, the system optimizer may determine the optimal configuration setting to be applied based on table 700 of FIG. 7 and current workload class in the foreground. For example, if the current workload is CPU intensive and the information handling system is running on DC power, then the system optimizer may determine that the optimal configuration setting is BatteryRT_CPU.

However, if there is a change in the system condition, such as the information handling system is now plugged into an AC power source, then the system optimizer may dynamically determine that the optimal configuration setting may be changed to Acoustics_CPU. The system optimizer may also determine that use Acoustics GPU if the current workload running in the foreground is now GPU intensive, wherein the CPU intensive workload running in the foreground is now running in the background, and the information handling system is still plugged into the AC power source. Thus, the system optimizer may dynamically determine if there is a change in the optimal configuration setting to be applied based on changes to the system condition and the currently running workload class within the user's preference. For example, the optimal configuration setting if there is a different workload class running. The system optimizer may also change the optimal configuration setting applied to the information handling system based on a change to the user optimization selection or preference. The method may then proceed to block 635, wherein the system optimizer may apply the optimal configuration setting determined in block 625. The method may loop back to block 605.

FIG. 7 shows table 700 of optimal configuration settings for each workload class and priority according to the user's preference. Table 700 can be used to store records of optimal configuration settings, wherein each configuration setting is associated with a certain optimization priority and workload class. Table 700 may have been generated based on the benchmarking operation performed during the development of the system platform. The optimal configuration settings were selected based on an analysis of the benchmarking operation results. Each row in table 700 may identify an optimal configuration setting associated with an optimization priority and workload class. Although the optimization priority shown in table 700 includes performance, power, acoustics, and battery runtime, additional optimization priorities than shown may be included. Each column in table 700 may identify a workload class that includes CPU-intensive, GPU-intensive, mixed, network-intensive, and I/O-intensive workloads.

The configuration settings may be mapped to one or more USTT modes and/or operating system power modes shown in FIG. 4. For example, the configuration setting that prioritizes performance may be mapped to the ultra-performance mode. The configuration settings that prioritizes power mode may be mapped to cool mode or power efficiency (cool) mode while the configuration settings that prioritizes acoustics mode may be mapped to the quiet mode, and the configuration settings that prioritizes battery runtime may be mapped to the optimized mode or the balanced mode. In addition, the configuration settings may include settings associated with application features, hardware features, or other system settings. Also, feature settings and/or other system settings may be disabled, such as when the features and/or the system settings are irrelevant or cause conflict. Conflicts with the mappings, the settings, and/or power modes may be resolved by the system optimizer based on rules and/or policies. In another example, system optimizer 240 may select an alternate configuration setting that supports the conflict, such as choosing a quiet mode among the USTT modes or power efficiency (quiet) mode among the operating system power modes if acoustics is a priority.

It will be understood that the optimal configuration settings associated with workload classes and user priorities shown in table 700 are exemplary and that table 700 may include a greater number or a lesser number of priorities and optimal configuration settings. Table 700 may be stored in a persistent storage device and used by the system optimizer in determining optimal configuration settings according to pre-selected user experience. Table 700 may also be stored in a volatile memory for runtime access.

FIG. 8 shows a table 800 of control settings based on a user's preference. Each row in table 800 may identify a control setting associated with user preference identified via user interface 300. Each column may identify the user's optimization priorities. A control setting to be applied by the system optimizer may be identified based on the user preference and priorities. The control settings may be associated with an optimal configuration setting in table 700 of FIG. 7. For example, a lookup table may be used for the association. In another example, the association may be performed through a set of rules and/or policies. It will be understood that the user experiences and corresponding control settings shown in table 800 are exemplary and that table 800 may include a greater or lesser number of user experiences. Table 800 may be stored in a persistent storage device and used by the system optimizer in determining optimal configuration settings according to pre-selected user experience. Table 800 may also be stored in a volatile memory for runtime access. For example, control setting 1 may be used when the user prioritizes performance mode over power and acoustics mode.

As used herein, a hyphenated form of a reference numeral refers to a specific instance of an element and the un-hyphenated form of the reference numeral refers to the collective or generic element. Thus, for example, benchmark tool “210-1” refers to an instance of a widget class, which may be referred to collectively as benchmark tools “210” and any one of which may be referred to generically as a benchmark tool “210.”

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIG. 5, and FIG. 6 show example blocks of method 500 and method 600 in some implementations, method 500 and method 600 may include additional blocks, fewer blocks, different blocks, or differently arranged blocks than those depicted in FIG. 5 and FIG. 6. Those skilled in the art will understand that the principles presented herein may be implemented in any suitably arranged processing system. Additionally, or alternatively, two or more of the blocks of method 500 and method 600 may be performed in parallel. For example, blocks 610 and 615 of method 600 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
determining, by a processor, a workload class currently running in a foreground of an information handling system;
determining an optimization priority selected by a user;
determining a configuration setting based on the workload class currently running in the foreground of the information handling system and the optimization priority selected by the user; and
applying the configuration setting to the information handling system.

2. The method of claim 1, further comprising determining a power source of the information handling system.

3. The method of claim 1, wherein the configuration setting is based on metrics associated with a simulated workload class.

4. The method of claim 1, wherein the optimization priority is selected via a user interface.

5. The method of claim 1, wherein the determining of the configuration setting is based on a power source of the information handling system.

6. The method of claim 1, further comprising determining another configuration setting in response to a different workload class running in the foreground.

7. The method of claim 1, further comprising determining another configuration setting in response to a change in the optimization priority selected by the user.

8. An information handling system, comprising:
a processor; and
a memory storing instructions that when executed cause the processor to perform operations including:
determining a workload class currently running in a foreground of the information handling system;
determining a selected optimization priority;
determining a configuration setting based on the workload class currently running in the foreground of the information handling system and the selected optimization priority; and
applying the configuration setting to the information handling system.

9. The information handling system of claim 8, wherein the operations further comprise determining a power source of the information handling system.

10. The information handling system of claim 8, wherein the configuration setting is based on metrics associated with a simulated workload class.

11. The information handling system of claim 8, wherein the optimization priority is selected via a user interface.

12. The information handling system of claim 8, wherein the determining the configuration setting is based on a power source of the information handling system.

13. The information handling system of claim 8, wherein the operations further comprise determining another configuration setting in response to a different workload class running in the foreground.

14. A non-transitory computer-readable medium to store instructions that are executable to perform operations comprising:
determining a workload class currently running in a foreground of an information handling system;
determining an optimization priority selected by a user;
determining a configuration setting based on the workload class currently running in the foreground of the information handling system and the selected optimization priority; and
applying the configuration setting to the information handling system.

15. The non-transitory computer-readable medium of claim 14, wherein the operations further comprise determining a power source of the information handling system.

16. The non-transitory computer-readable medium of claim 14, wherein the configuration setting is based metrics associated with a simulated workload class.

17. The non-transitory computer-readable medium of claim 14, wherein the optimization priority is selected via a user interface.

18. The non-transitory computer-readable medium of claim 14, wherein the determining of the configuration setting is based on a power source of the information handling system.

19. The non-transitory computer-readable medium of claim 14, wherein the operations further comprise determining another configuration setting in response to a different workload class running in the foreground.

20. The non-transitory computer-readable medium of claim 14, wherein the operations further comprise determining another configuration setting in response to a change in the optimization priority selected by the user.
